(19) United States
(12) Patent Application Publication
(10) Pub. No.: US 2002/0015057 A1
(43) Pub. Date: Feb. 7, 2002

(54) System and method for aggregating website contents

(76) Inventor: Byung Joon Park, Ulsan (KR)

Correspondence Address: Aaron R. Wininger, Esq., Squire, Sanders & Dempsey LLP, 600 Hansen Way, Palo Alto, CA, 94304, US

(21) Appl. No.: 09/918,679

(22) Filed: Jul. 27, 2001

Related U.S. Application Data
(60) Provisional application No. 60/305,332, filed on Jul. 13, 2001.

(30) Foreign Application Priority Data
Apr. 2, 2001 (KR) 2001-0017438
Aug. 1, 2000 (KR) 2000-0044538

(51) Int. Cl. G09G 5/00

(52) U.S. Cl. 345/738; 709/218; 709/219; 709/246

(57) ABSTRACT

A system for aggregating website content comprises an engine capable to compute source coordinates of at least one user-selected portion of at least one web page located on the network, compute placement coordinates for the at least one user-selected portion, and store the computed source coordinates, computed placement coordinates, and at least one web page identifier in a file in the memory device.

### PRIORITY REFERENCE TO PRIOR APPLICATIONS

This application claims benefit of Korean patent application Ser. No. 2001-0017438, entitled “A Method and System for Objecting and Operating Web Contents,” filed on Apr. 2, 2001, by inventor Byung Joon Park. In addition, this application claims benefit of Korean patent application Ser. No. 2000-0044538, entitled “A Method of Converting Web Contents Information into Objects in the System Folder,” filed on Aug. 1, 2000, by inventor Byung Joon Park. Further, this application claims benefit of and incorporates by reference U.S. Patent Application No. ______, entitled “DMWV Systems and Methods,” filed on Jul. 13, 2001, by inventor Byung Joon Park.

### TECHNICAL FIELD

This invention relates generally to displaying websites, and more particularly, but not exclusively, provides a system and method for aggregating contents from multiple websites into a single page.

### BACKGROUND

Conventional web browsers, such as Internet Explorer, enable users to load and display a website in a browser window. For example, a user can load and view a first website, such as CNN.com, and then open a second browser window and load and view a second website, such as CNBC.com. However, this process can be time consuming as it requires a user to load a plurality of websites when only a small amount of information from each website may be wanted.

Accordingly, a new and improved system and method may be needed for viewing content from a plurality of websites.

### SUMMARY

The present invention provides a system for aggregating user-selected content from a plurality of websites into a single browser window. The system comprises a Dynamic Multi Web View (“DMWV”) engine communicatively coupled to a web browser, such as Internet Explorer. The DMWV engine enables a user to select portions of website pages, convert the selected portions into objects, and then place the objects into a single file for viewing. The engine converts portions of a website into objects by determining pixel coordinates of the selected portions and storing the coordinates with a corresponding website address in a file. When a viewer views the file, the engine loads the website specified by the website address and filters website content so that only content specified by the coordinates are displayed.

The present invention further provides a method for aggregating user-selected content from a plurality of websites. The method comprises converting user-selected portions of websites into objects, the objects comprising coordinates and associated website addresses; and storing the objects into a file. A method for viewing the aggregated content comprises loading the website addresses stored in the file; filtering the websites for content at the stored corresponding coordinates; and displaying the filtered content.

The system and method may advantageously enable a user to aggregate content from multiple websites into a single file and view the single file.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram illustrating a network topography in accordance with an embodiment of the invention;

FIG. 2 is a block diagram illustrating a client computer of FIG. 1;

FIG. 3 is a block diagram illustrating memory of a client computer according to an embodiment of the invention;

FIG. 4 illustrates a block diagram of the DMWV Operating Program of FIG. 3;

FIG. 5 illustrates a flowchart diagram of a method to aggregate web contents from multiple websites;

FIG. 6 illustrates a flowchart diagram of a method to edit files storing aggregated content from multiple websites;

FIG. 7 illustrates a diagram of an example aggregated website content file according to an embodiment of the invention;

FIG. 8 illustrates a diagram of moving an object from a first file to a second file according to an embodiment of the invention;

FIG. 9 illustrates a diagram of creating a file having a single object and an associated desktop icon;

FIG. 10 illustrates a diagram of editing a file by rearranging placement of objects within the file; and

FIG. 11 illustrates a block diagram of a representative memory device according to another embodiment of the invention.

### DETAILED DESCRIPTION OF THE ILLUSTRATED EMBODIMENTS

The following description is provided to enable any person skilled in the art to make and use the invention, and is provided in the context of a particular application and its requirements. Various modifications to the embodiments will be readily apparent to those skilled in the art, and the generic principles defined herein may be applied to other embodiments and applications without departing from the spirit and scope of the invention. Thus, the present invention is not intended to be limited to the embodiments shown, but is to be accorded the widest scope consistent with the principles, features and teachings disclosed herein.

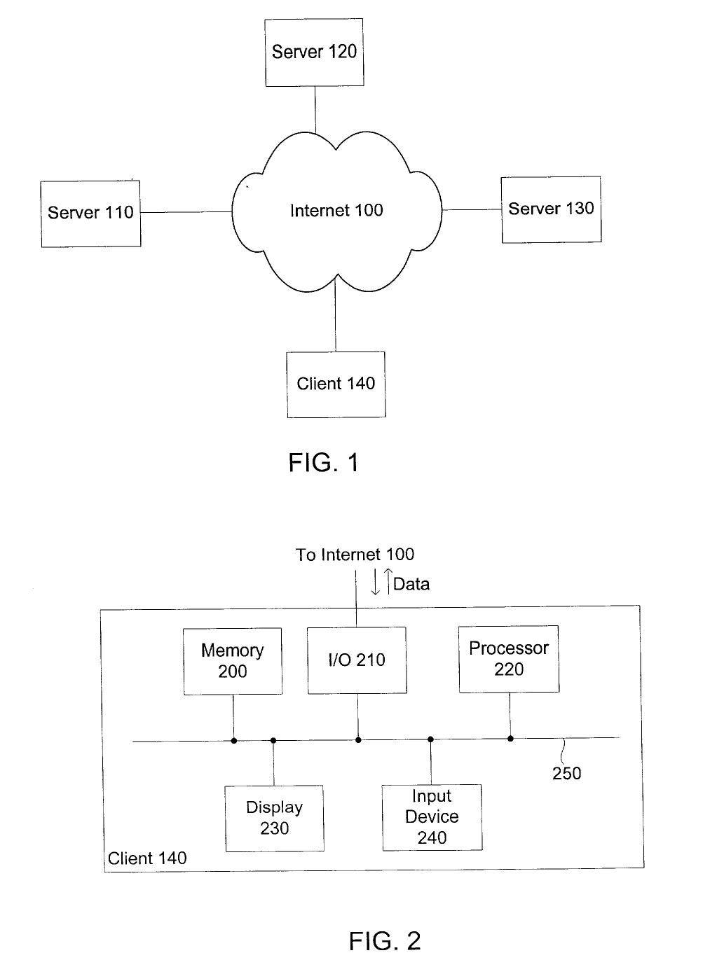

FIG. 1 is a block diagram illustrating a network topography according to an embodiment of the invention. The topography includes servers 110, 120 and 130, and client 140 communicatively coupled to a network, such as Internet 100. Servers 110, 120 and 130 may include web servers hosting websites. Client 140 may include a personal digital assistant (“PDA”), wireless phone, computer, or any other device capable to communicate with a network. Further, although only three servers and one client are shown coupled to the network, in an embodiment of the invention, any number of clients and servers may be coupled to the Internet 100.

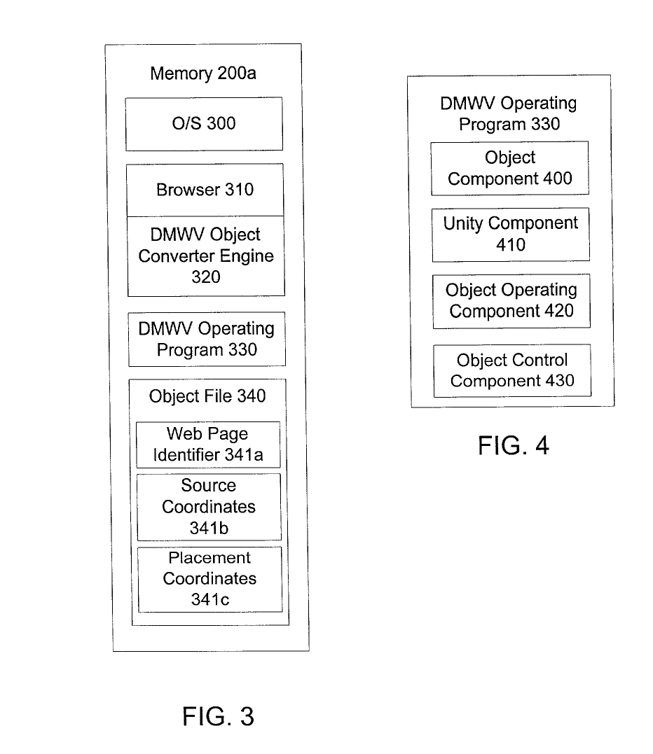

FIG. 2 is a block diagram illustrating a client 140 in accordance with an embodiment of the invention. The client 140 includes a memory device 200, input/output (I/O) interface 210, processor 220, display 230 and input device 240, all communicatively coupled together via system bus 250. In an embodiment of the invention, memory 200 may include RAM, ROM, FLASH memory, a hard drive, disk drive, or any other type of memory device or combination of memory devices. The contents of memory 200 will be discussed in further detail in conjunction with FIG. 3. I/O interface 210 communicatively couples client 140 to Internet 100. Processor 220 may include an Intel Pentium® processor or other processor and processes programs stored in memory 200. Display 230 may include a monitor or other device for displaying data. Input device 240 may include a mouse, trackball, keyboard or other input device or combination thereof.

FIG. 3 illustrates a block diagram of a representative memory device 200a according to an embodiment of the invention. It is noted that the memory 200a and 200b described below are some of the possible embodiments of the memory device 200 that is shown in FIG. 2. Memory 200a includes an operating system (O/S) 300, such as Windows NT®; a web browser 310, such as Internet Explorer; a Dynamic Multi Web View (DMWV) Object Converter Engine 320; and a DMWV Operating Program 330. In an embodiment of the invention, engine 320 may be installed within browser 310, thereby expanding the functionality of browser 310. Browser 310, in conjunction with engine 320 and operating program 330 enable aggregation of content from a plurality of websites into a single file, as will be discussed further below. In an alternative embodiment of the invention, engine 320 may comprise a plurality of sub-engines (not shown), including a source coordinate engine capable to determine coordinates of user-selected content from a source web page; a placement coordinate engine capable to determine placement coordinates of the user-selected content; and a storage engine capable to store objects comprising source coordinates, placement coordinates and web page identifiers in a file.

Memory 200a may also include one or more object files, such as example object file 340, which includes a web page identifier 341a, source coordinates 341b, and placement coordinates 341c. Note that while object file 340 only includes a single web page identifier, a single set of source coordinates and a single set of placement coordinates, object files in general may contain a plurality of identifiers, source coordinates and placement coordinates. Web page identifier 341a is an address, such as a web page address, than identifies a web page. Source coordinates are coordinates of user-selected content from a web page. Placement coordinates are coordinates for displaying the user-selected content. Source and placement coordinates may be x, y format, polar format, or any other format or combination of formats. If the user-selected content is square or rectangular in shape, source coordinates 341b and placement coordinates 341c may comprises only two sets of points. If the user-selected content is non-rectangular or non-square, source coordinates 341b and placement coordinates 341c may each include more than two sets of points.

In another embodiment of the invention, object files may also include scroll information that indicates creation of a scroll bar; signature information indicating an ID of a company; names of web contents; unique IDs of web content, etc.

To open a previously created file, such as file 340, a user can use any conventional technique, such as double clicking an icon corresponding to the file or selecting an “Open” command from a “File” menu, etc. In an embodiment of the invention, opening a file containing objects will automatically load the expanded web browser 310 (FIG. 3) incorporating engine 320 (FIG. 3), which can then display objects in the file and enable editing of the file.

FIG. 4 illustrates a block diagram of DMWV Operating Program 330, which includes an object component 400, a unity component 410, an object operating component 420 and an object control component 430. Program 330, in response to instructions from engine 320, saves user-selected web contents as objects in a file. Further, the program 330 may enable a user to later view and edit the file. More specifically, object component 400, which can be an Active X component in one embodiment, converts user-selected web contents into objects, as will be discussed further below. Unity component 410 saves the objects into an alias file, enabling a user to later view the objects. Unity component 410 also does filtering of web objects when a user views a file holding objects, as will be discussed further below. Object operating component 420 controls operation of object component 400 and controls the operation of objected contents. Further, object operating component 420 may include a picture-processing program that creates a background image of web contents. Object control component 430 manages and edits objects stored in files when in a browser 310 environment.

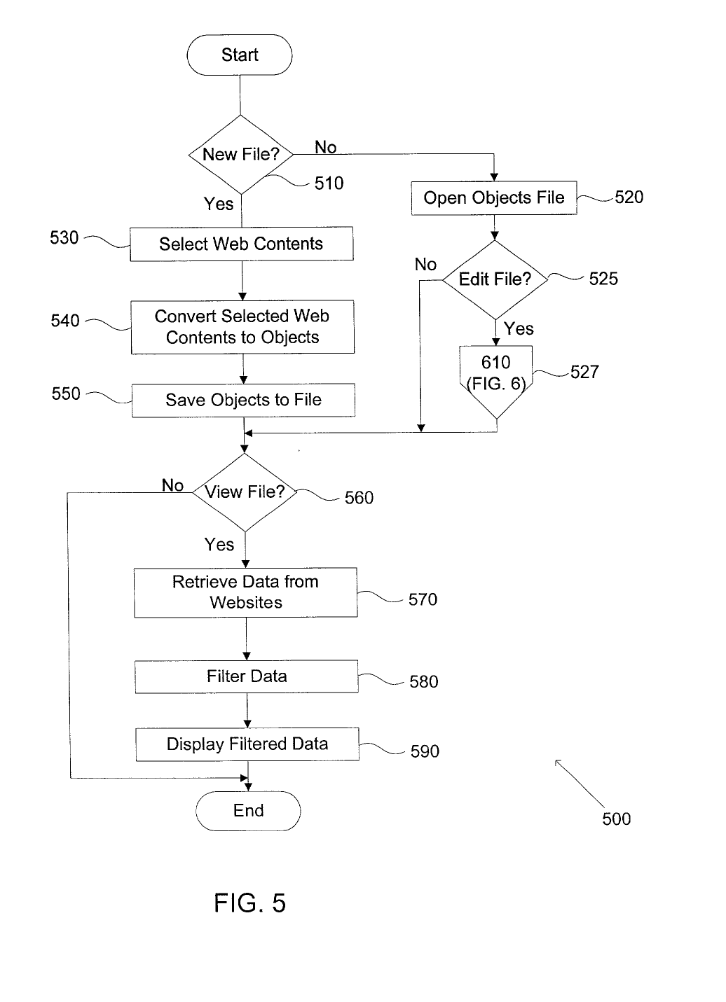

FIG. 5 illustrates a flowchart diagram of a method 500 to aggregate web contents from multiple websites. In an embodiment of the invention, engine 320, in conjunction with program 330, may perform the method depicted by flowchart diagram 500. Note that if engine 320 and program 330 are not installed in memory 200a, then they must be installed from a website or recording medium storing them.

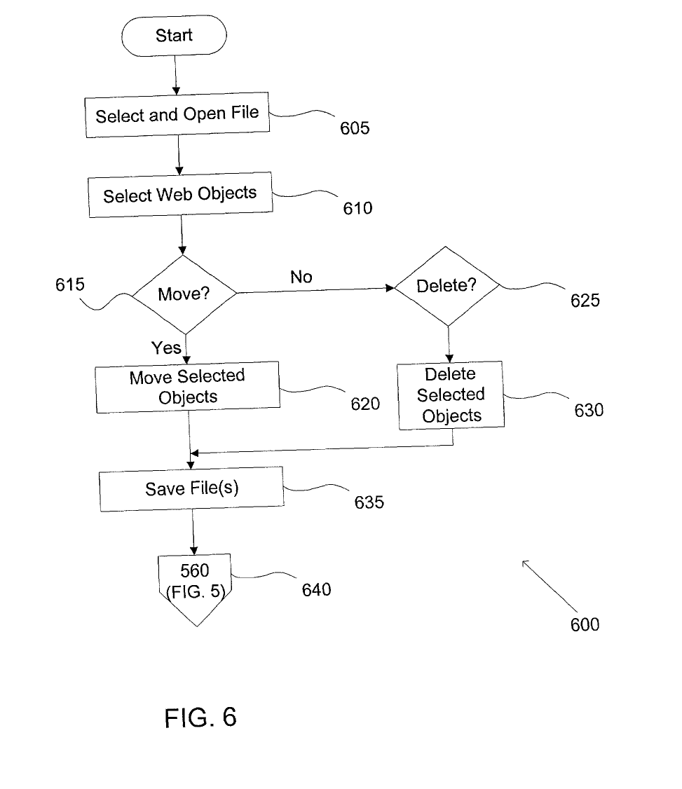

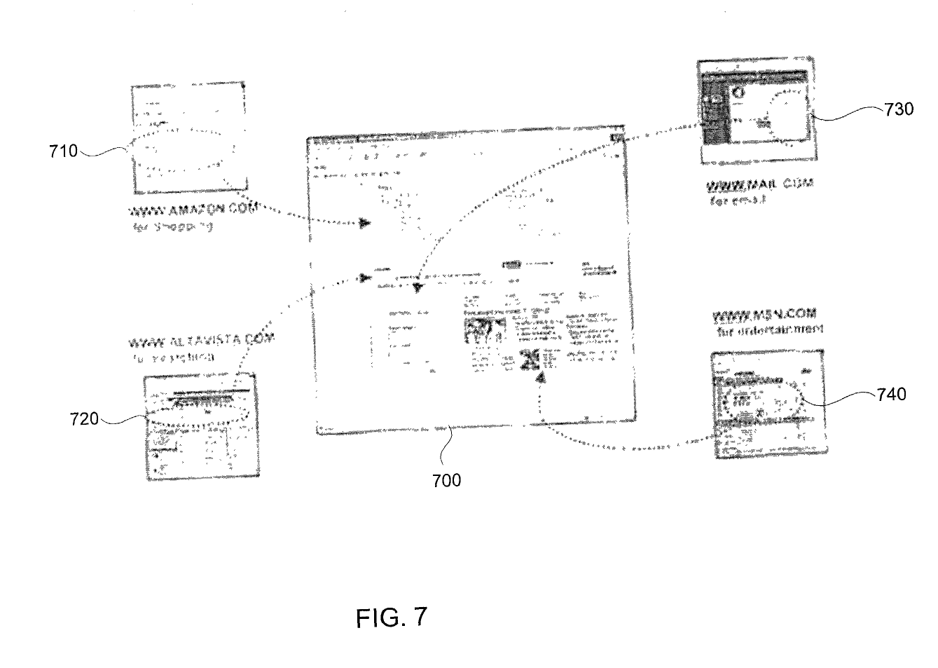

First, it is determined if a new file is to be created (510) based on a user selecting a “new” function, which will open a blank page. If not, a previously created file from a memory device, such as memory 200a, may be opened (520), and possibly edited (525, 527) as will be discussed in further detail in conjunction with FIG. 6. If a new file is to be created (510), web contents from one or more websites are selected (530) and then converted (540) into objects. As can be seen in FIG. 7, any portion of a website may be selected and converted into an object. To select a portion of a website, a user can use an input device 240, such as a mouse, to enable a transparent window over content the user is interested in. The user can then select a move button that instructs engine 320 to convert (540) the selected content to objects. Further, the user can drag the contents selected by the transparent window to a desktop on display 230 or into a new file.

To convert a portion of a website into an object, coordinates, such as x, y pixel coordinates, polar coordinates, etc. of the selected portion are calculated. For example, for a square or rectangular portion, the top left corner and the bottom right corner of the selected portion may be calculated. For a non-square or non-rectangular area, such as an oval, hexagon, etc., additional points may be calculated.

Afterwards, the objects are saved (550) to a file in memory, such as memory 200a. Alternatively, changes to a previously-saved file may be saved. To save an object to a file, the coordinates of the object as well as the website address or other website identifier is saved to the file. In addition, display coordinates, such as x, y pixel coordinates, for placement of the objects in a browser window are also saved to the file. For example, in FIG. 7, coordinates from the portion selected from Amazon.com, Amazon.com's website address or other identifier, and display coordinates for placement of the object when viewed in a new file (i.e., top left corner) are stored. Similar data may be stored in the file for Altavista, MSN, and mail.com.

Next, it is determined if the file is to be viewed (560). If the file is to be viewed, then data from the websites specified in the file are retrieved (570) and stored in buffers. The data is then filtered (580), which comprises identifying retrieved data from the websites that falls inside the corresponding stored portion coordinates. The filtered data is then displayed (590) on a display device, such as display 230, at locations specified by the display coordinates in the data file and the method then ends. Note that each time a file is viewed (by either loading the file, by pressing a refresh button in the browser 310, or by any other technique) updated web objects will be displayed corresponding to real-time web content on the corresponding websites. Further, in an embodiment of method 500, the saved file may be set as a homepage. The method then ends.

FIG. 6 illustrates a flowchart diagram 600 of a method to edit files storing aggregated content from multiple websites. In an embodiment of the invention, engine 320, in conjunction with program 330, may perform the method depicted by flowchart diagram 600. First, a file is selected and opened (605). Next, web objects to edit are selected (610).

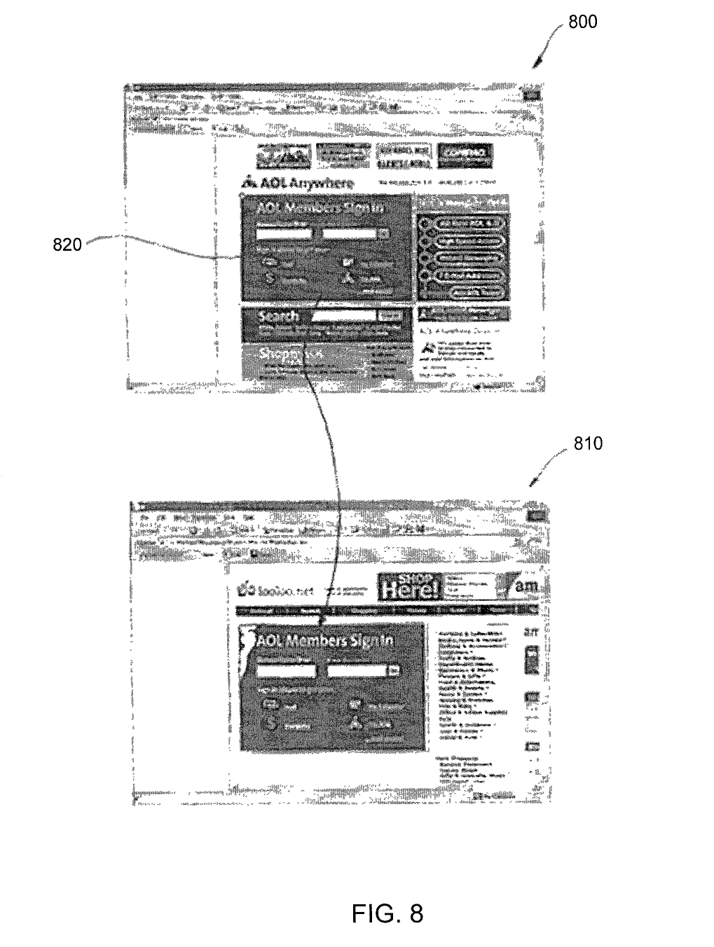

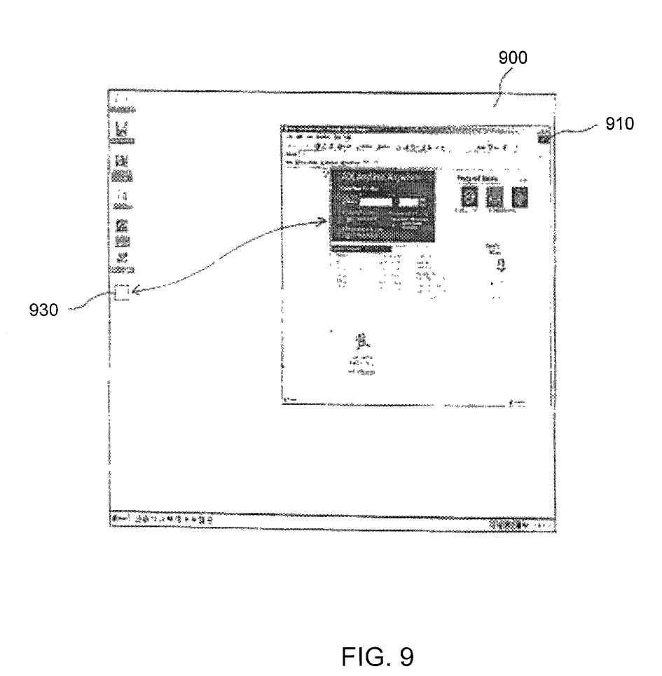

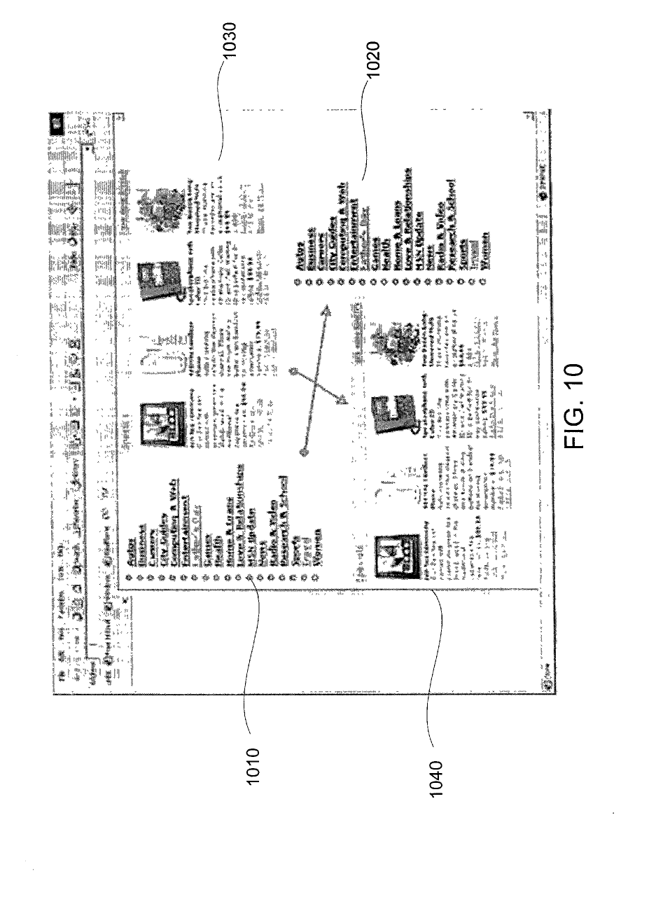

Next it is determined whether the selected object(s) is to be moved (615). Movement can include rearranging placement of objects as shown in FIG. 10 or can include moving an object from a first file to a second file, as shown in FIG. 8. If an object is to be moved from a first file to a second file, then all data from the first file relating to the object is deleted and stored instead in the second file. However, stored display coordinates of the moved object may differ according to a user's preferences. If an object is to be moved only within a single file, then the stored display coordinates are changed accordingly in the single file. Movement may also include generating a new file with a corresponding desktop icon by dragging a selected object from a file to the desktop, as shown in FIG. 9. The new file will include all object data from the original file. Alternatively, an object may be moved into a file by dragging a desktop icon into an opened file, thereby copying all object data associated with the icon into the file.

If the selected objects are not to be moved, it is determined if the objects are to be deleted (625). If the objects are to be deleted, the selected objects are deleted (630) by deleting all data in the file corresponding to the object.

If the file includes moved objects or if objects were deleted, the file (or files) may then be saved (635) and then viewed (560; FIG. 5) as discussed above. In an embodiment of the invention, objects may also be resized. The method then ends.

FIG. 7 illustrates a diagram of an example aggregated website content file 700 according to an embodiment of the invention. File 700 includes website content from four websites: Amazon.com, Altavista, mail.com, and MSN. Specifically, engine 320 in conjunction with program 330 converts portion 710 for shopping from Amazon.com; portion 720 for searching from Altavista; portion 730 for email from mail.com; and portion 740 for entertainment from MSN.com into objects and stores the objects in file 700 per the methods disclosed above in conjunction with FIG. 5 and FIG. 6. Whenever file 700 is loaded, program 330, in conjunction with engine 320, retrieves data from all four websites, filters the data per object coordinates stored in the file 700, and displays the filtered data in locations according to display coordinates in the file 700.

FIG. 8 illustrates a diagram of moving an object from a first file to a second file, according to an embodiment of the invention. A user may select object 820 and move it from file 800 to file 810. Accordingly, program 330 in conjunction with engine 320 cuts all data associated with object 820 in file 800 and places the data in file 810. However, the display coordinates associated with object 820 may change according to where the user drags the object 820.

FIG. 9 illustrates a diagram of creating a file having a single object and an associated desktop icon. A user may select and drag an object from a file 910 to desktop 900 to create a new file and an associated icon 930. Accordingly, program 330 in conjunction with engine 320 copies all data associated with an object in file 910 and places the copied data in a new file associated with icon 930. In addition, if a user drags icon 930 into a file, such as file 910, then the object associated with the icon will be placed in the file.

FIG. 10 illustrates a diagram of editing a file by rearranging placement of objects within the file. A user may move objects in a file by selecting the objects and dragging them to new locations. For example, an object located at location 1010 can be moved to location 1020 and an object at location 1030 can be moved to location 1040. During movement, program 330, in conjunction with engine 320, changes the display coordinates associated with each object to match the location that the objects were dragged to.

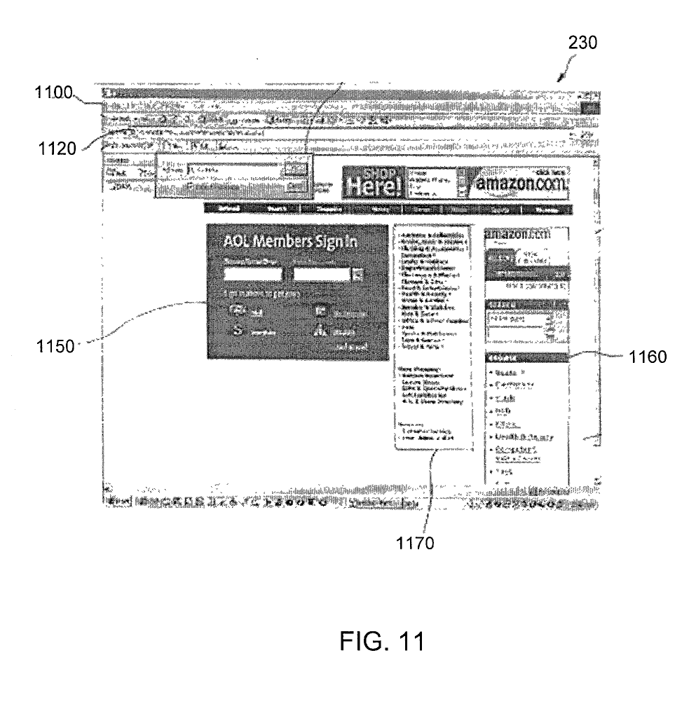

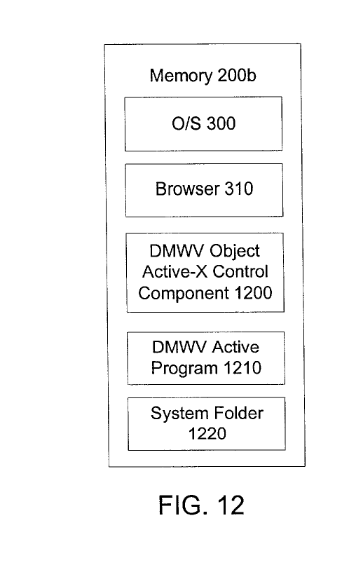

FIG. 11 illustrates a diagram of editing a file having a plurality of objects. Display 230 displays a file having a name as indicated in address window 1120. A user can select an object using transparent window 1170. Some objects from other websites include an AOL member sign in window 1150 and an Amazon.com search engine window 1160.

FIG. 12 illustrates a block diagram of a representative memory device 200b according to an embodiment of the invention. Memory device 200b includes O/S 300; browser 310; DMWV Object Active-X Control Component 1200, DMWV Active Program 1210; and system folder 1220. Component 1200 and program 1210 can perform substantially the same functions as engine 320 and program 330 as discussed above. Further, component 1200, in conjunction with program 1210, may also save objects into a system folder and further subdivide the system folder into subfolders.

An additional feature of program 1210 is a sort feature to sort web contents. When an object file is opened, sorting sorts objects in the file left, right and center, in that order. Further, program 1210 may also enable a vertical band function, as will be discussed further in conjunction with FIG. 13.

FIG. 13 illustrates a diagram of using a vertical bar function of program 1210. Window 1300 includes three sub windows: an object window PI, dictionary window P2, and a display window P3. Object window P1 displays a list of objects in a system folder, such as system folder 1120. Alternatively, window P1 may display a list of objects in window P3. Further, the objects listed in window P1 may be grouped into subfolders. Dictionary window P2 displays web contents of objects selected in window P1. As can be seen in window P3, objects displayed include an AOL object 1310b, a shop object, a People Chat object, and a Web Center Object. A list of these objects by name is also displayed in window P1.

The foregoing description of the preferred embodiments of the present invention is by way of example only, and other variations and modifications of the above-described embodiments and methods are possible in light of the foregoing teaching. Although the network sites are being described as separate and distinct sites, one skilled in the art will recognize that these sites may be a part of an integral site, may each include portions of multiple sites, or may include combinations of single and multiple sites. Further, components of this invention may be implemented using a programmed general purpose digital computer, using application specific integrated circuits, or using a network of interconnected conventional components and circuits. Connections may be wired, wireless, modem, etc. The embodiments described herein are not intended to be exhaustive or limiting. The present invention is limited only by the following claims.

What is claimed is:

1. A method, comprising:
receiving identification of a web page portion on a web page having a web page address;
computing web page portion location information of the web page portion on the website;
determining customized location information for displaying the web page portion on a customized web page;
storing the web page portion location information, the web page address, and the customized display location information.

2. The method of claim 1, wherein the customized display location information is based on user specifications.

3. The method of claim 1, wherein the web page portion location information and the customized display location information each include at least two sets of x and y coordinate points.

4. The method of claim 1, wherein the web page portion location information and the customized display location information each include a plurality of sets of x and y coordinate points.

5. The method of claim 1 further comprising displaying the customized web page.

6. The method of claim 5, wherein the displaying comprises:
retrieving the web page corresponding to the web page address;
identifying data in the web page specified by the web page portion location information; and
displaying the identified data.

7. The method of claim 6, wherein the displaying displays the identified data at a position specified by the customized display location information.

8. A machine-readable medium having stored thereon instructions to:
receive identification of a web page portion on a web page having a web page address;
compute web page portion location information of the web page portion on the website;
determine customized location information for displaying the web page portion on a customized web page;
store the web page portion location information, the web page address, and the customized display location information.

9. The machine-readable medium of claim 8, wherein the customized display location information is based on user specifications.

10. The machine-readable medium of claim 8, wherein the web page portion location information and the customized display location information each include at least two sets of x and y coordinate points.

11. The machine-readable medium of claim 8, wherein the web page portion location information and the customized display location information each include a plurality of sets of x and y coordinate points.

12. The machine-readable medium of claim 8, further comprising an instruction to display the customized web page.

13. The machine-readable medium of claim 12, wherein the instruction to display further comprises instructions to:
retrieve the web page corresponding to the web page address;
identify data in the web page specified by the web page portion location information; and
display the identified data.

14. The machine-readable medium of claim 13, wherein the instruction to display the identified data further comprises an instruction display the identified data at a position specified by the customized display location information.

15. An system, comprising:
means for receiving identification of a web page portion on a web page having a web page address;
means for computing web page portion location information of the web page portion on the website;
means for determining customized location information for displaying the web page portion on a customized web page;
means for storing the web page portion location information, the web page address, and the customized display location information.

16. An system, comprising:
a memory device;
a source coordinate engine, communicatively coupled to a network, capable to compute source coordinates of at least one user-selected portion of at least one web page located on the network,
a placement coordinate engine, communicatively coupled to the network, capable to compute placement coordinates for the at least one user-selected portion, and
a storage engine, communicatively coupled to the placement coordinate engine, source coordinate engine, and memory device, capable to store the computed source coordinates, computed placement coordinates, and at least one web page identifier in the memory device.

17. The system of claim 16, further comprising an input device communicatively coupled to the placement coordinate engine, and wherein the placement coordinates are based on user specifications received via the input device.

18. The system of claim 16, wherein the at least one web page identifier includes a web address.

19. The system of claim 16, wherein the source coordinates and placement coordinates each include at least two sets of x and y coordinate points.

20. The system of claim 16, wherein the source coordinates and placement coordinates each include a plurality of sets of x and y coordinate points.

21. The system of claim 16, further comprising a display device communicatively coupled to the storage engine.

22. The system of claim 21, further comprising a display engine capable to retrieve at least one web page corresponding to the at least one web page identifier; identify data in the at least one web page that is within the computed source coordinates; and display the identified data on the display device.

23. The system of claim 22, wherein the display engine is further capable to display the identified data at the computed placement coordinates on the display device.

24. The system of claim 16, wherein the storage engine is further capable to store the computed source coordinates, computed placement coordinates, and at least one web page identifier in a folder in the memory device.

25. The system of claim 16, wherein the storage engine is further capable to delete the computed source coordinates, computed placement coordinates, and at least one web page identifier from the memory device.

26. The system of claim 16, wherein the storage engine is further capable to edit the computed placement coordinates.

27. The system of claim 16, wherein the storage engine is further capable to create an icon corresponding to a selected set of computed source coordinates.

28. The system of claim 16, wherein the storage engine is further capable to store signature information of a company related to the at least one user-selected portion; scroll information, at least one content name corresponding to the at least one user-selected portion; and at least one content ID corresponding to the at least one user-selected portion.

29. The system of claim 16, wherein the storage engine is further capable to sort the at least one user-selected portion of at least one web page.
